(19) United States
(12) Patent Application Publication
(10) Pub. No.: US 2026/0176851 A1
(43) Pub. Date: Jun. 25, 2026

(54) WATER FAUCET AND WATER PURIFICATION EQUIPMENT WITH MINERALIZATION

(71) Applicant: Guangdong Lizi Technology Co., Ltd., Foshan (CN)

(72) Inventors: Xing Zhan, Foshan (CN); Longbiao He, Foshan (CN); Guoxiang Chen, Foshan (CN); Yutai Huang, Foshan (CN); Wenbin Chen, Foshan (CN); Jiawei Chen, Foshan (CN); Yijie Hao, Foshan (CN); Mingyao Li, Foshan (CN)

(21) Appl. No.: 19/026,494

(22) Filed: Jan. 17, 2025

(30) Foreign Application Priority Data
Dec. 20, 2024 (CN) 202411896625.0

(51) Int. Cl. E03C 1/04; C02F 1/00; C02F 1/66; C02F 1/68

(52) U.S. Cl. CPC E03C 1/0404; C02F 1/003; C02F 1/008; C02F 1/66; C02F 1/68; C02F 2201/005; C02F 2209/008; C02F 2209/06; C02F 2209/10; C02F 2209/40; C02F 2307/06; E03C 2201/40

(57) ABSTRACT

A water faucet and water purification equipment with mineralization are provided. The water faucet includes: a body, a water faucet filter element, an obtaining module, and a display module. The body is provided with a mineralization waterway; the water faucet filter element and the obtaining module are arranged at the mineralization waterway; the obtaining module is configured to obtain a PH value and/or a Total Dissolved Solids (TDS) value of the mineralization waterway; the display module is arranged at the body and is configured to display the PH value and/or the TDS value obtained by the obtaining module. Water in the mineralization waterway is mineralized through the water faucet filter element. After the obtaining module obtains the PH value and/or the TDS value, the PH value and/or the TDS value is displayed through the display module, to achieve visualization of water quality of the water faucet.

### CROSS REFERENCE TO RELATED APPLICATIONS

The present application claims the benefit of Chinese Patent Application No. 202411896625.0 filed on Dec. 20, 2024, the contents of which are incorporated herein by reference in their entirety.

### TECHNICAL FIELD

The present disclosure relates to the technical field of water faucets, and in particular, to a water faucet and water purification equipment with mineralization.

### BACKGROUND

At present, with the continuous improvement of the living standard, people pay more and more attentions to drinking water. Water that people can drink can roughly include tap water, purified water, and mineral water. The tap water contains impurities, bacteria, and heavy metals. The purified water is acidic and is not beneficial for an acid-base balance of a human body. A water faucet is a terminal device for water. A traditional water faucet used in the current market is only limited to safe water use, and may not be used to test and display a PH value and a Total Dissolved Solids (TDS) value of water flowing out of the water faucet.

### SUMMARY

In view of this, the present disclosure provides a water faucet and water purification equipment with mineralization. The water faucet can obtain and test a PH value and/or a TDS value of water flowing out of the water faucet.

The present disclosure provides the following technical solutions:

A water faucet includes: a body, a water faucet filter element, an obtaining module, and a display module,
wherein the body is provided with a mineralization waterway; the water faucet filter element is arranged at the mineralization waterway; the obtaining module is arranged at the mineralization waterway; the obtaining module is configured to obtain a PH value and/or a TDS value of the mineralization waterway;
the display module is arranged at the body; and the display module is configured to display the PH value and/or the TDS value obtained by the obtaining module.

Further, the obtaining module includes a first obtaining unit and a second obtaining unit;
the water faucet filter element has a water inlet end and a water outlet end; the first obtaining unit is arranged at the water inlet end; the first obtaining unit is configured to obtain a PH value and/or a TDS value of water at the water inlet end; the second obtaining unit is arranged at the water outlet end; and the second obtaining unit is configured to obtain a PH value and/or a TDS value of the water at the water outlet end.

Further, the water faucet further includes a controller,
wherein the controller is connected to the first obtaining unit and the second obtaining unit respectively; and the controller is configured to: obtain signals of the first obtaining unit and the second obtaining unit and output the signals to the display module.

Further, the water faucet further includes a communication unit,
wherein the communication unit is connected to the first obtaining unit and the second obtaining unit; and the communication unit is configured for wireless communication with the controller.

Further, both the first obtaining unit and the second obtaining unit are TDS sensors.

Further, the display module includes a signal display area, a numerical value display area, a control area, and a PH/TDS display area.

Further, different control modes are set in the control area, and corresponding touch buttons are arranged in the control area.

Further, the body includes a main body portion and a connecting portion;
the main body portion is rotationally connected to the connecting portion; the connecting portion is provided with an accommodating chamber; and the first obtaining unit, the second obtaining unit, the communication unit, the controller, and the water faucet filter element are all arranged in the accommodating chamber.

Further, the main body portion is provided with a mounting area, and the display module is arranged in the mounting area.

Further, the body further includes an adjustment waterway and a control valve, the control valve is connected to the mineralization waterway and the adjustment waterway, the control valve is configured to control a water inlet volume of the mineralization waterway and a water inlet volume of the adjustment waterway.

The present disclosure further provides water purification equipment with mineralization. The water purification equipment includes:
a water purifier and the water faucet. The water faucet is connected to the water purifier.

Further, the obtaining module includes a first obtaining unit and a second obtaining unit;
the water faucet filter element has a water inlet end and a water outlet end; the first obtaining unit is arranged at the water inlet end; the first obtaining unit is configured to obtain a PH value and/or a TDS value of water at the water inlet end; the second obtaining unit is arranged at the water outlet end; and the second obtaining unit is configured to obtain a PH value and/or a TDS value of the water at the water outlet end.

Further, the water purification equipment with mineralization includes a controller,
wherein the controller is connected to the first obtaining unit and the second obtaining unit respectively; and the controller is configured to obtain signals of the first obtaining unit and the second obtaining unit and output the signals to the display module.

Further, the water purification equipment with mineralization includes a communication unit,
wherein the communication unit is connected to the first obtaining unit and the second obtaining unit; and the communication unit is configured for wireless communication with the controller.

Further, both the first obtaining unit and the second obtaining unit are TDS sensors.

Further, the display module includes a signal display area, a numerical value display area, a control area, and a PH/TDS display area.

Further, the body includes a main body portion and a connecting portion;
the main body portion is rotationally connected to the connecting portion; the connecting portion is provided with an accommodating chamber; and the first obtaining unit, the second obtaining unit, the communication unit, the controller, and the water faucet filter element are all arranged in the accommodating chamber.

Further, the main body portion is provided with a mounting area, and the display module is arranged in the mounting area.

Further, the body includes an adjustment waterway and a control valve, the control valve is connected to the mineralization waterway and the adjustment waterway, the control valve is configured to control a water inlet volume of the mineralization waterway and a water inlet volume of the adjustment waterway.

Further, the water purification equipment with mineralization includes a mineralization filter element and a water purification filter element,
wherein the mineralization filter element is connected in series to the water purification filter element, and the mineralization filter element is connected to the mineralization waterway and supplies water to the mineralization waterway.

The mineralization waterway is arranged in the body; and the water faucet filter element is arranged at the mineralization waterway. Water in the mineralization waterway is mineralized through the water faucet filter element. Furthermore, the obtaining module is arranged at the mineralization waterway. The PH value and/or the TDS value of the mineralization waterway is obtained through the obtaining module. After the obtaining module obtains the PH value and/or the TDS value, the PH value and/or the TDS value at the mineralization waterway is displayed through the display module of the body, so that a user can more intuitionally observe the PH value and/or the TDS value at the mineralization waterway.

### BRIEF DESCRIPTION OF THE DRAWINGS

To describe the technical solutions in the embodiments of the present disclosure more clearly, the following briefly describes the accompanying drawings required for describing the implementations. Apparently, the accompanying drawings in the following description show some implementations of the present disclosure, and a person of ordinary skill in the art may still derive other drawings from these accompanying drawings without creative efforts.

FIG. 1 is a schematic structural diagram I of a water faucet according to an embodiment of the present disclosure;

FIG. 2 is a schematic structural diagram II of a water faucet according to an embodiment of the present disclosure;

FIG. 3 is a schematic structural diagram I of a display module according to an embodiment of the present disclosure;

FIG. 4 is a schematic structural diagram II of a display module according to an embodiment of the present disclosure;

FIG. 5 is a schematic structural diagram III of a display module according to an embodiment of the present disclosure;

FIG. 6 is a schematic diagram I of an entire structure of a water faucet according to an embodiment of the present disclosure;

FIG. 7 is a schematic diagram II of an entire structure of a water faucet according to an embodiment of the present disclosure;

FIG. 8 is cross-sectional view of a water faucet according to an embodiment of the present disclosure; and

FIG. 9 is a schematic structural diagram of water purification equipment with mineralization according to an embodiment of the present disclosure.

### Descriptions of Reference Numerals

100: water faucet; 10: body; 11: mineralization waterway; 12: main body portion; 121: mounting area; 13: connecting portion; 131: accommodating chamber; 20: water faucet filter element; 21: water inlet end; 22: water outlet end; 30: obtaining module; 31: first obtaining unit; 32: second obtaining unit; 40: display module; 41: signal display area; 42: numerical value display area; 43: control area; 44: PH/TDS display area; 50: controller; 60: communication unit; 70: adjustment waterway; 80: control valve; 200: water purification equipment with mineralization; 210: water purifier; 220: mineralization filter element; and 230: water purification filter element.

### DETAILED DESCRIPTION OF THE EMBODIMENTS

The technical solutions in the embodiments of the present disclosure will be clearly and completely described below with reference to the drawings in the embodiments of the present disclosure, and it is obvious that the described embodiments are only a part of the embodiments of the present disclosure but not all of them. All other embodiments obtained by a person of ordinary skill in the art based on the embodiments of present disclosure without making creative efforts shall fall within the protection scope of present disclosure.

This specification and claims of the present disclosure, and terms “first” and “second” in the above accompanying drawings are configured to distinguish different objects, but are unnecessarily configured to describe a specific sequence. In addition, the term “include”, “has”, and any variant thereof are intended to cover a non-exclusive inclusion. For example, a process, method, system, product, or device that includes a series of steps or units is not limited to the listed steps or units; and instead, further optionally includes a step or unit that is not listed, or further optionally includes another step or unit that is intrinsic to the process, method, product, or device.

Reference to “an embodiment” or “implementation” herein means that a particular feature, structure or characteristic described in conjunction with an embodiment or an implementation may be included in at least one embodiment of the present disclosure. The appearance of this phrase in various places in the specification does not necessarily refer to the same embodiment, nor is it a separate or alternative embodiment that is mutually exclusive with other embodiments. It is explicitly and implicitly understood by those skilled in the art that the embodiments described herein may be combined with other embodiments.

At present, with the continuous improvement of the living standard, people pay more and more attentions to drinking water. Water that people can drink can roughly include tap water, purified water, and mineral water. The tap water contains impurities, bacteria, and heavy metals. The purified water is acidic and is not beneficial for an acid-base balance of a human body. A water faucet is a terminal device for water. A traditional water faucet used in the current market is only limited to safe water use, and may not be used to test and display a PH value and a Total Dissolved Solids (TDS) value of water flowing out of the water faucet.

In view of this, this implementation provides a water faucet and water purification equipment with mineralization. The water faucet can obtain and test a PH value and/or a TDS value of water flowing out of the water faucet.

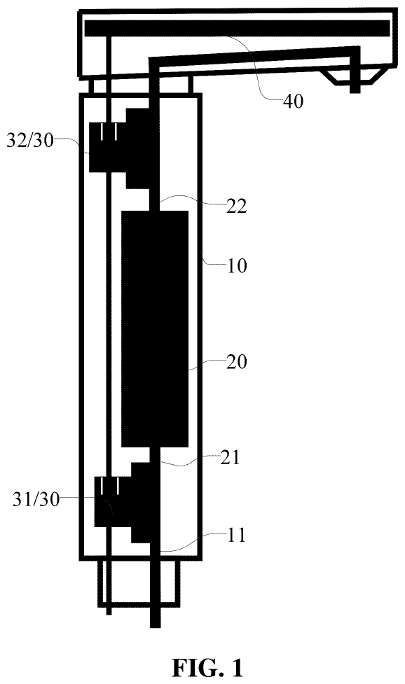

Referring to FIG. 1, a water faucet 100 includes: a body 10, a water faucet filter element 20, an obtaining module 30, and a display module 40,
wherein the body 10 is provided with a mineralization waterway 11; the water faucet filter element 20 is arranged at the mineralization waterway 11; the obtaining module 30 is arranged at the mineralization waterway 11; the obtaining module 30 is configured to obtain a PH value and/or a TDS value of the mineralization waterway 11;
the display module 40 is arranged at the body 10; and the display module 40 is configured to display the PH value and/or the TDS value obtained by the obtaining module 30.

The mineralization waterway 11 is arranged in the body 10; and the water faucet filter element 20 is arranged at the mineralization waterway 11. Water in the mineralization waterway 11 is mineralized through the water faucet filter element 20. Furthermore, the obtaining module 30 is arranged at the mineralization waterway 11. The PH value and/or the TDS value of the mineralization waterway 11 is obtained through the obtaining module 30. After the obtaining module 30 obtains the PH value and/or the TDS value, the PH value and/or the TDS value at the mineralization waterway 11 is displayed through the display module 40 of the body 10, so that a user can more intuitionally observe the PH value and/or the TDS value at the mineralization waterway 11.

Referring to FIG. 1, in some implementations, the obtaining module 30 includes a first obtaining unit 31 and a second obtaining unit 32;
the water faucet filter element 20 has a water inlet end 21 and a water outlet end 22; the first obtaining unit 31 is arranged at the water inlet end 21; the first obtaining unit 31 is configured to obtain a PH value and/or a TDS value of water at the water inlet end 21; the second obtaining unit 32 is arranged at the water outlet end 22; and the second obtaining unit 32 is configured to obtain a PH value and/or a TDS value of the water at the water inlet end 21.

It can be understood that the above obtaining module 30 includes the first obtaining unit 31 and the second obtaining unit 32. The water faucet filter element 20 has the water inlet end 21 and the water outlet end 22. The first obtaining unit 31 can be arranged at the water inlet end 21. The PH value of the water at the water inlet end 21 and/or the TDS value of the water inlet end 21 can be tested through the first obtaining unit 31. The second obtaining unit 32 can be arranged at the water outlet end 22. The PH value of the water at the water outlet end 22 or the TDS value of the water outlet end 22 can be tested through the second obtaining unit 32. After obtaining the PH values or the TDS values of a current waterway, the first obtaining unit 31 and the second obtaining unit 32 send the PH values or the TDS values to the display module 40. The display module 40 can display the PH values and TDS values of the current water at the water outlet and the water inlet end 21 in real time after processing the PH values and TDS values obtained by the first obtaining unit 31 and the second obtaining unit 32.

It should be noted that the above first obtaining unit 31 and the above second obtaining unit 32 are both configured to obtain relevant data of the current water, such as, to obtain relevant data such as the PH values and/or the TDS values and/or heavy metal contents and/or microorganism contents of the current water.

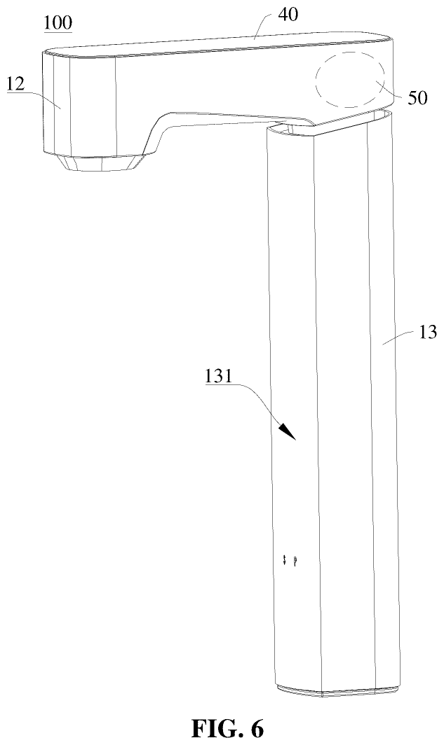

Referring to FIG. 6, in some implementations, the water faucet 100 further includes a controller 50,
wherein the controller 50 is connected to the first obtaining unit 31 and the second obtaining unit 32 respectively; and the controller 50 is configured to: obtain signals of the first obtaining unit 31 and the second obtaining unit 32 and output the signals to the display module 40.

It can be understood that the controller 50 is arranged outside the water faucet 100 or inside the water faucet 100, and is connected to the first obtaining unit 31 and the second obtaining unit 32 respectively. In this way, the controller 50 can obtain the PH value and/or the TDS value of the water at the water inlet end 21 of the water faucet filter element 20 through the first obtaining unit 31, and obtain the PH value and/or the TDS value of the water at the water outlet end 22 of the water faucet filter element 20 through the second obtaining unit 32. The relevant data obtained by the first obtaining unit 31 and the second obtaining unit 32 is sent to the controller 50, and the controller 50 can process the obtained relevant data and send the data to the display module 40 for displaying. This can achieve visualization of the water quality at the water inlet end 21 of the water faucet filter element 20 and the water quality at the water outlet end 22 of the water faucet filter element 20.

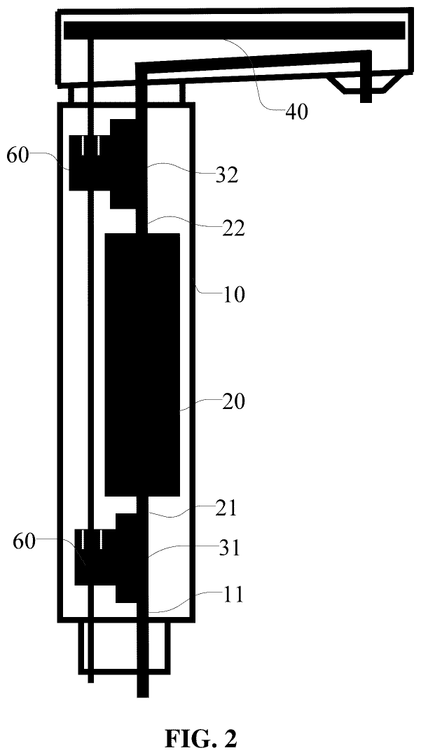

Referring to FIG. 2, in some implementations, the water faucet 100 further includes a communication unit 60,
wherein the communication unit 60 is connected to the first obtaining unit 31 and the second obtaining unit 32; and the communication unit 60 is configured for wireless communication with the controller 50.

It can be understood that the communication unit 60 is further arranged in the body 10, and the above communication unit 60 is respectively connected to the first obtaining unit 31 and the second obtaining unit 32. After the first obtaining unit 31 obtains the TDS value and/or the PH value at the water inlet end 21, and the second obtaining unit 32 obtains the TDS value and/or the PH value at the water outlet end 22, the first obtaining unit 31 and the second obtaining unit 32 can communicate with the display module 40 through the communication unit 60. The display module 40 has a communication function, so that the display module 40 can wirelessly communicate with the communication unit 60. In this way, the data can be sent to the display module 40 through the communication unit 60, and the display module 40 can display the data after processing the relevant data.

Referring to FIG. 1 and FIG. 2, in some implementations, both the first obtaining unit 31 and the second obtaining unit 32 are TDS sensors.

It can be understood that both the first obtaining unit 31 and the second obtaining unit 32 are the TDS sensors. A total dissolved solids (TDS) content of water is measured through the two TDS sensors. This can make water quality test more accurate. Meanwhile, the TDS sensors have a simple design, are easy to operate, and can directly output digital signals which can be directly received and used by the display module 40, which can reduce the volume and complexity of the entire system. Moreover, the TDS sensors can convert TDS values into PH values after simple calculation by the controller 50, so that the PH values and the TDS values can be obtained only through the TDS sensors.

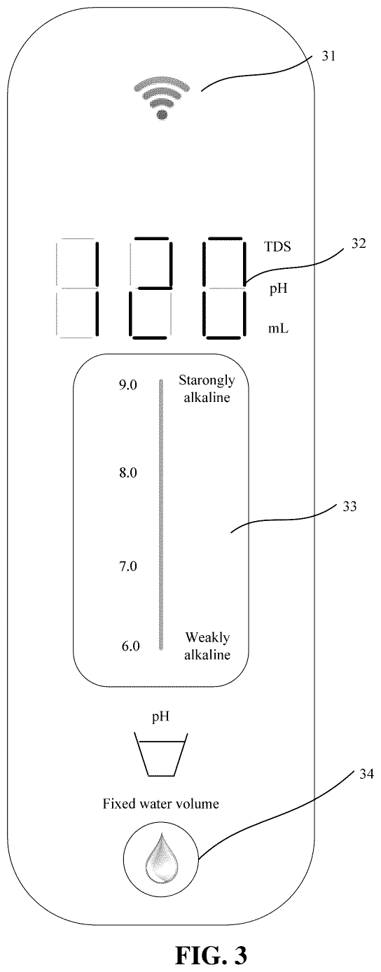

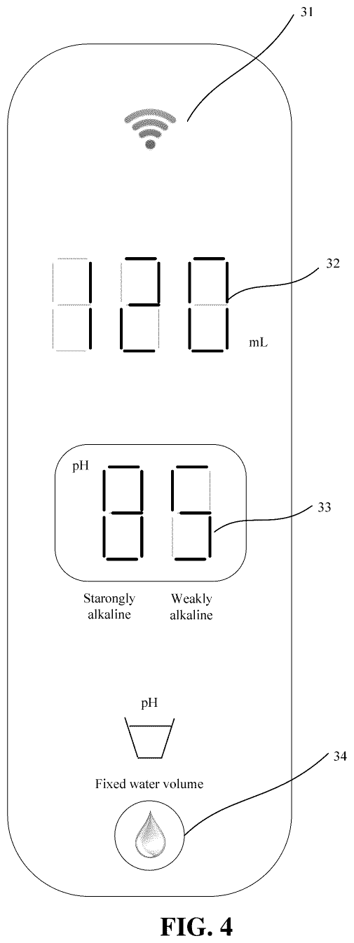

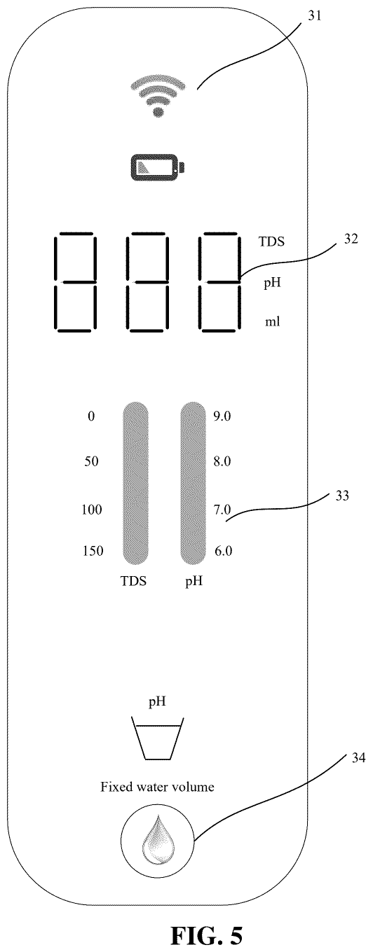

Referring to FIG. 3 to FIG. 5, in some implementations, the display module 40 includes a signal display area 41, a numerical value display area 42, a control area 43, and a PH/TDS display area 44.

It can be understood that to facilitate observation and control by the display module 40, the display module 40 is divided into a plurality of display areas. Specifically, the display module 40 is divided into the signal display area 41, the numerical value display area 42, the control area 43, and the PH/TDS display area 44. The above signal display area 41 is configured to display a current communication state of the main body portion. The numerical value display area 42 is configured to display a specific value of the current PH/TDS display area 44. The control area 43 can be provided with buttons for setting a PH value of outlet water or a water outlet volume or for pausing water outputting. The PH/TDS display area 44 is configured to display PH/TDS of current water in a bar chart (shown in FIG. 3 to FIG. 5).

Different control modes may be set in the control area 43, and corresponding touch buttons may be arranged in the control area 43. A TDS value or a PH value of water output from the water faucet 100 is adjusted through the touch button. For example, if one control area 43 is set to a fixed TDS value or PH value, the touch button may correspondingly set PH=7, PH=7.5, and PH=8. If another control area 43 is configured to adjust the PH value of the water output from the water faucet 100 by plus or minus, the touch button can be set to have a plus or minus sign, and the different buttons in the control area 43 can adjust current values. For example, if a user requires drinking water with a PH value of 7.3, the user can adjust the water through the button PH=7.5 and the minus sign button. This can improve the portability of button adjustment and make it more convenient to preset a PH value for the water faucet 100.

Of course, in some other implementations, only the control area 43 and the display area can be set. Or, other setting modes are used.

Referring to FIG. 1 and FIG. 6, in some implementations, the body 10 includes a main body portion 12 and a connecting portion;
the main body portion 12 is rotationally connected to the connecting portion; the connecting portion is provided with an accommodating chamber; and the first obtaining unit 31, the second obtaining unit 32, the communication unit 60, the controller 50, and the water faucet filter element 20 are all arranged in the accommodating chamber.

It can be understood that the body 10 includes the connecting portion and the main body portion 12. The main body portion 12 is rotationally arranged on the connecting portion, and the main body portion 12 is perpendicular to the connecting portion. The structural design that the main body portion 12 is perpendicular to the connecting portion helps to improve the stability of the device, to reduce structural displacement or tilting, improve the stability of the water faucet 100, and further reduce the flowing resistance, thereby improving the water flowing efficiency. Furthermore, it can also facilitate the turning of the water faucet 100.

It can be understood that the above connecting portion is provided with an accommodating chamber. The communication unit 60, the first obtaining unit 31, the second obtaining unit 32, and the controller 50 are arranged in the accommodating chamber. The communication unit 60 can be electrically connected to the first obtaining unit 31 and the second obtaining unit 32, and the controller 50 may be wirelessly connected to the communication unit 60. Data is sent to the controller 50 through the communication unit 60 via a wireless signal. Signal transmission can be performed using BLUETOOTH, WI-FI, and other relevant protocols or modules.

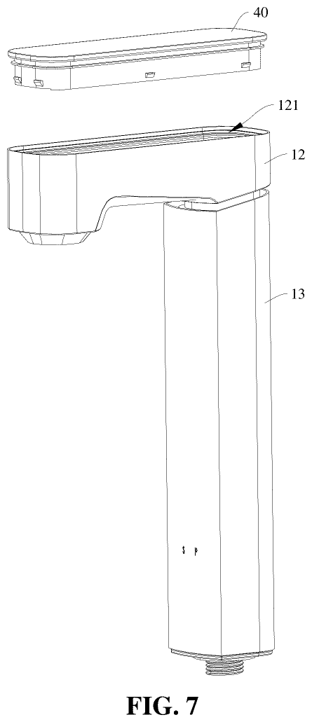

Referring to FIG. 7, in some implementations, the main body portion 12 is provided with a mounting area 121, and the display module 40 is arranged in the mounting area 121.

It can be understood that the main body portion 12 is a water outlet portion of the water faucet 100, and is rotationally arranged at the connecting portion. Furthermore, the mounting area 121 is arranged on one side of the main body portion 12 away from the connecting portion. The mounting area 121 is recessed in the main body portion 12. The mounting area 121 is configured to mount the display module 40. On the one hand, the mounting area 121 is configured for facilitating mounting of the display module 40, and on the other hand, the mounting area 121 is for facilitating a user to observe and adjust relevant parameters after the display module 40 is mounted in the mounting area 121.

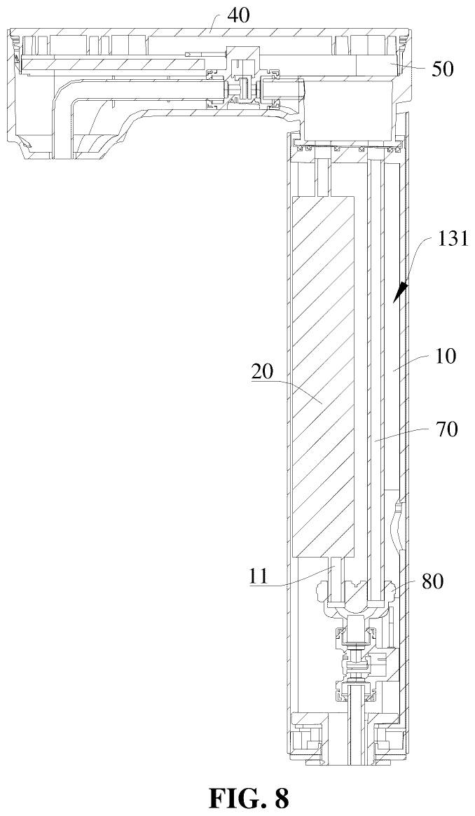

Referring to FIG. 8, in some implementations, the body 10 further includes an adjustment waterway 70 and a control valve 80.

The control valve 80 is respectively connected to the mineralization waterway 11 and the adjustment waterway 70, and is configured to control a water inlet volume of the mineralization waterway 11 and a water inlet volume of the adjustment waterway 70.

It can be understood that the control valve 80 is connected to the mineralization waterway 11 and the adjustment waterway 70, so the control valve 80 can achieve the purpose of adjusting water flow rates of the mineralization waterway 11 and the adjustment waterway 70 by controlling the water flow rates. The water flow rates of different waterways are adjusted to make water in the mineralization waterway 11 mixed with water in the adjustment waterway 70 before the water is output from the water faucet 100. This can adjust the PH value of the water.

In some implementations, the control valve 80 is connected to the controller 50. The controller 50 can control the above control valve 80 to make the water flow rate in the adjustment waterway 70 and the water flow rate in the control waterway meet a usage need of a user. Through the cooperation of the first obtaining unit 31, the second obtaining unit 32, the control valve 80, and the controller 50, the water output from the water faucet 100 can meet an expectation of the user or meet a standard for drinking water.

Specifically, both the first obtaining unit 31 and the second obtaining unit 32 can test the PH value of water currently output by the body 10 and the PH value of water currently input by the body 10. When it is tested that the PH value of the currently output water is small or large, the body 10 can adjust both the water flow rate in the mineralization waterway 11 and the water flow rate in the adjustment waterway 70 through the control valve 80. For example, when the PH value of the output water is large, the water flow rate of the mineralization waterway 11 can be decreased and the water flow rate of the adjustment waterway 70 can be increased, to decrease the PH value. When the PH value of the output water is small, the water flow rate of the mineralization waterway 11 can be increased and the water flow rate of the adjustment waterway 70 can be decrease, to increase the PH value.

The first obtaining unit 31 can test a PH value or a TDS value in a water inlet waterway. The second obtaining unit 32 is arranged at a water outlet waterway. The second obtaining unit 32 can test a PH value or a TDS value in the water outlet waterway. In this way, the current inlet water and the current outlet water in the water faucet 100 can be tested. By obtaining a difference between the TDS value of the water inlet waterway and the TDS value of the water outlet waterway or a difference between the PH value of the water inlet waterway and the PH value of the water outlet waterway, the control valve 80 can adjust the water entering the mineralization waterway 11 and the water entering the adjustment waterway 70 according to the difference, obtained in real time, between the TDS values and the difference, obtained in real time, between the PH values, to make the output water meet a water utilization need of a user.

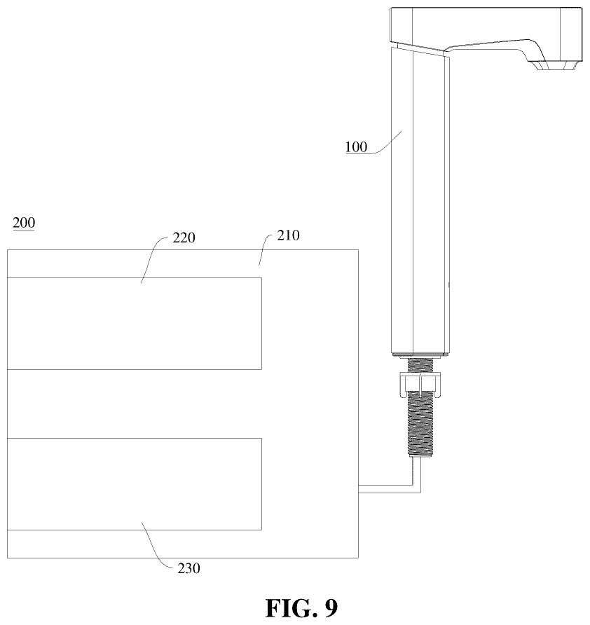

Referring to FIG. 9, the present disclosure further provides water purification equipment with mineralization 200. The water purification equipment with mineralization 200 includes:
a water purifier 210 and the water faucet 100 connected to the water purifier 210.

It can be understood that the above water purification equipment with mineralization 200 includes the water purifier 210 and the water faucet 100. The water purifier 210 is configured to purify municipal water, and purified water enters the water faucet 100. The water faucet 100 can achieve the purpose of adjusting a water flow rate of the mineralization waterway 11 and a water flow rate of the adjustment waterway 70 through the control valve 80 in the water faucet 100. By adjusting the water flow rates of different waterways, water in the mineralization waterway 11 and water in the adjustment waterway 70 can be mixed before the water is output from the water faucet 100, to output water for different needs.

Referring to FIG. 9, in some implementations, the water purification equipment with mineralization 200 includes a mineralization filter element 220 and a water purification filter element 230,
wherein the mineralization filter element 220 is connected in series to the water purification filter element 230, and the mineralization filter element 220 is connected to the mineralization waterway 11 and supplies water to the mineralization waterway 11.

It can be understood that the above water purifier 210 includes the mineralization filter element 220 and the water purification filter element 230. The water purification filter element 230 is connected to the mineralization filter element 220. After being purified by the water purification filter element 230, water flows out and enters the mineralization filter element 220. The mineralization filter element 220 preliminarily mineralizes the water and outputs it to the water faucet 100.

Reference to “an embodiment” or “implementation” in the present disclosure means that a particular feature, structure or characteristic described in conjunction with an embodiment may be included in at least one embodiment of the present disclosure. The appearance of this phrase in various places in the specification does not necessarily refer to the same embodiment, nor is it a separate or alternative embodiment that is mutually exclusive with other embodiments. It is explicitly and implicitly understood by those skilled in the art that the embodiments described in the present disclosure may be combined with other embodiments. In addition, it should be further understood that provided that there is no contradiction between the features, structures or characteristics described in the various embodiments of the present disclosure, the features, structures, or characteristics can be arbitrarily combined to form another embodiment that does not depart from the spirit and scope of the technical solutions of the present disclosure.

Finally, it should be noted that the above implementations are only configured to explain the technical solutions of the present disclosure and not intended to limit the technical solutions. Although the present disclosure has been described in detail with reference to the preferred implementations, those of ordinary skill in the art should understand that the technical solutions of the present disclosure can be modified or equivalently replaced without departing from the spirit and scope of the technical solutions of the present disclosure.

What is claimed is:

1. A water faucet, comprising: a body, a water faucet filter element, an obtaining module, and a display module,
wherein the body is provided with a mineralization waterway; the water faucet filter element is arranged at the mineralization waterway; the obtaining module is arranged at the mineralization waterway; the obtaining module is configured to obtain a PH value and/or a Total Dissolved Solids (TDS) value of the mineralization waterway;
the display module is arranged at the body; and the display module is configured to display the PH value and/or the TDS value obtained by the obtaining module.

2. The water faucet according to claim 1, wherein the obtaining module comprises a first obtaining unit and a second obtaining unit;
the water faucet filter element has a water inlet end and a water outlet end; the first obtaining unit is arranged at the water inlet end; the first obtaining unit is configured to obtain a PH value and/or a TDS value of water at the water inlet end; the second obtaining unit is arranged at the water outlet end; and the second obtaining unit is configured to obtain a PH value and/or a TDS value of the water at the water outlet end.

3. The water faucet according to claim 2, further comprising a controller,
wherein the controller is connected to the first obtaining unit and the second obtaining unit respectively; and the controller is configured to obtain signals of the first obtaining unit and the second obtaining unit and output the signals to the display module.

4. The water faucet according to claim 3, further comprising a communication unit,
wherein the communication unit is connected to the first obtaining unit and the second obtaining unit; and the communication unit is configured for wireless communication with the controller.

5. The water faucet according to claim 4, wherein both the first obtaining unit and the second obtaining unit are TDS sensors.

6. The water faucet according to claim 5, wherein the display module comprises a signal display area, a numerical value display area, a control area, and a PH/TDS display area.

7. The water faucet according to claim 6, wherein different control modes are set in the control area, and corresponding touch buttons are arranged in the control area.

8. The water faucet according to claim 6, wherein the body comprises a main body portion 12 and a connecting portion;
the main body portion is rotationally connected to the connecting portion; the connecting portion is provided with an accommodating chamber; and the first obtaining unit, the second obtaining unit, the communication unit, the controller, and the water faucet filter element are all arranged in the accommodating chamber.

9. The water faucet according to claim 8, wherein the main body portion is provided with a mounting area, and the display module is arranged in the mounting area.

10. The water faucet according to claim 1, wherein the body further comprises an adjustment waterway and a control valve, the control valve is connected to the mineralization waterway and the adjustment waterway, the control valve is configured to control a water inlet volume of the mineralization waterway and a water inlet volume of the adjustment waterway.

11. Water purification equipment with mineralization, wherein the water purification equipment with mineralization comprises:
a water purifier; and
the water faucet according to claim 1, wherein the water faucet is connected to the water purifier.

12. The water purification equipment with mineralization according to claim 11, wherein the obtaining module comprises a first obtaining unit and a second obtaining unit;
the water faucet filter element has a water inlet end and a water outlet end; the first obtaining unit is arranged at the water inlet end; the first obtaining unit is configured to obtain a PH value and/or a TDS value of water at the water inlet end; the second obtaining unit is arranged at the water outlet end; and the second obtaining unit is configured to obtain a PH value and/or a TDS value of the water at the water outlet end.

13. The water purification equipment with mineralization according to claim 12, further comprising a controller,
wherein the controller is connected to the first obtaining unit and the second obtaining unit respectively; and the controller is configured to obtain signals of the first obtaining unit and the second obtaining unit and output the signals to the display module.

14. The water purification equipment with mineralization according to claim 13, further comprising a communication unit,
wherein the communication unit is connected to the first obtaining unit and the second obtaining unit; and the communication unit is configured for wireless communication with the controller.

15. The water purification equipment with mineralization according to claim 14, wherein both the first obtaining unit and the second obtaining unit are TDS sensors.

16. The water purification equipment with mineralization according to claim 15, wherein the display module comprises a signal display area, a numerical value display area, a control area, and a PH/TDS display area.

17. The water purification equipment with mineralization according to claim 16, wherein the body comprises a main body portion and a connecting portion;
the main body portion is rotationally connected to the connecting portion; the connecting portion is provided with an accommodating chamber; and the first obtaining unit, the second obtaining unit, the communication unit, the controller, and the water faucet filter element are all arranged in the accommodating chamber.

18. The water purification equipment with mineralization according to claim 17, wherein the main body portion is provided with a mounting area, and the display module is arranged in the mounting area.

19. The water purification equipment with mineralization according to claim 18, wherein the body further comprises an adjustment waterway and a control valve, the control valve is connected to the mineralization waterway and the adjustment waterway, the control valve is configured to control a water inlet volume of the mineralization waterway and a water inlet volume of the adjustment waterway.

20. The water purification equipment with mineralization according to claim 11, comprising a mineralization filter element and a water purification filter element,
wherein the mineralization filter element is connected in series to the water purification filter element, and the mineralization filter element is connected to the mineralization waterway and supplies water to the mineralization waterway.
